(19) United States
(12) Patent Application Publication
(10) Pub. No.: US 2017/0287657 A1
(43) Pub. Date: Oct. 5, 2017

(54) PUSH BUTTON SWITCH

(71) Applicant: OMRON Corporation, Kyoto-shi, Kyoto (JP)

(72) Inventors: Mamiko NAKA, Okayama-shi (JP); Kenshi NAGATA, Kurayoshi-shi (JP); Hiroaki FUJINO, Setouchi-shi (JP)

(73) Assignee: OMRON Corporation, Kyoto-shi, Kyoto (JP)

(21) Appl. No.: 15/510,251

(22) PCT Filed: Nov. 30, 2015
(86) PCT No.: PCT/JP2015/083587

§ 371 Date: Mar. 10, 2017

(30) Foreign Application Priority Data
Dec. 15, 2014 (JP) 2014-253499

(51) Int. Cl. H01H 13/14; H01H 13/70; H01H 13/06

(52) U.S. Cl. CPC H01H 13/14; H01H 13/06; H01H 13/70; H01H 2223/044; H01H 2235/01

(57) ABSTRACT

A push button switch includes a housing made up of a base and a cover, a first plunger mounted on the cover so as to be pushed down, a movable contacting piece configured to be driven by a push-down operation on the first plunger, a movable contact provided in the movable contacting piece, and a fixed contact disposed so as to come into and out of contact with the movable contact. Specifically, the movable contacting piece includes a movable contact piece provided with the movable contact, and an operation tongue piece disposed on at least one side of the movable contact piece and coupled with the movable contact piece so as to rotate integrally. The operation tongue piece is operated by the operation body of the first plunger to bring the movable contact into and out of contact with the fixed contact.

### TECHNICAL FIELD

The present invention relates to a push button switch, and particularly relates to a push button switch capable of performing a variety of operations.

### BACKGROUND ART

As a conventional push button switch, for example, there has been a refrigerator-freezer door switch including: a case; a fixed contact terminal provided in a vicinity of a center of the case; first and second switches having first and second movable contact plates that, come into and out of contact with the fixed contact terminal; a third switch provided between the first and second switches and made up of a third movable contact plate that comes into and out of the fixed contact terminal via a pressing spring; and first and second actuating levers obtained by integrally forming, on both ends of the case, (i) actuating pieces that are projectable and sinkable and turn on pieces disposed at positions which come into and output contact with the pressing spring of the third switch so as to cross the first and second switches. The first and second switches are turned on when the first and second actuating levers project. The first and second switches are turned off when the first and second actuating levers sink. The third switch is turned on only when both the first and second actuating levers sink (cf. PTL 1).

### CITATION LIST

### Patent Literature

PTL 1: Japanese Unexamined Patent Application Publication No. S63-140279

### SUMMARY OF INVENTION

### Technical Problem

However, in recent years, a refrigerator-freezer has been required not only to achieve both a capacity increase and size reduction, but also to ensure an area for installation of a heat insulator from the viewpoint of energy saving. For this reason, a door switch used for detecting opening and closing of a refrigerator-freezer door has also be required for size reduction.

While rubber packing is typically used for the refrigerator-freezer door, in view of deterioration in rubber packing over time, a long operation stroke has been required from, a detection position for opening and closing of the door to a pushing-in position.

Especially in some of door switches used for double doors adopted to middle-class and high-class refrigerator-freezers, a movable contact comes into contact with a fixed contact only when the both doors are closed (e.g., Japanese Unexamined Utility Model Application Publication No. H04-095288). In such a refrigerator-freezer switch, when a plunger is intended to be pushed-in to the pushing-in position so as to bring the movable contact into contact with the fixed contact by predetermined contact pressure, a long operation stroke is required in the plunger that drives the movable contact, thus causing the problem of not being able to reduce the size of the door switch.

It is an object of the present invention to provide a push button switch which is small in size and has a long operation stroke.

### Solution to Problem

In order to solve the above problem, a push button switch according to the present invention includes: a housing made up of a base and a cover; at least one plunger mounted on the cover so as to be pushed down, and having an operation body at a tip of an operating arm portion projecting sideways from an inner surface of the plunger; a movable contacting piece configured to De driven by a push-down operation on the plunger; a movable contact provided in the movable contacting piece; and a fixed contact disposed so as to come into and out of contact with the movable contact. The movable contacting piece includes a movable contact piece provided with the movable contact, and an operation tongue piece disposed on at least one side of the movable contact piece and coupled with the movable contact piece so as to rotate integrally. The operation tongue piece is operated by the operation body of the plunger to bring the movable contact into and out of contact with the fixed contact.

### Advantageous Effects of Invention

According to the present invention, since the movable contact piece and the operation tongue piece are formed in the movable contacting piece so as to rotate integrally, the operation can be performed using a small number of components. Hence it is possible to reduce a space occupied for internal components in the housing, and reduce the size of the push button switch.

Further, the operation tongue piece of the movable contacting piece can be operated by the operating arm portion projecting sideways from the inner surface of the plunger, to open and close the contacts. Hence it is possible to operate the movable contacting piece by use of the operating arm portion without increasing the size of the push button switch, while ensuring a long operation stroke.

As an embodiment of the present invention, it may be configured such that the movable contacting piece includes the movable contact piece provided with the movable contact, and the operation tongue pieces respectively disposed on both sides of the movable contact piece and coupled with the movable contact piece so as to rotate integrally. It may be configured such that a pair of the operation tongue pieces is respectively operated by a pair of the plungers to bring the movable contact into and out of contact with the fixed contact.

According to the present embodiment, in addition to the foregoing effect, it is possible to obtain a push button switch capable of detecting two objects to be detected, by use of one movable contact, while remaining small in size.

As another embodiment of the present invention, it may be configured such that, a first movable contacting piece and a second movable contacting piece are disposed so as to be symmetrical in the housing, the first movable contacting piece having the operation tongue piece disposed on one of both sides of the movable contact piece, the second movable contacting piece being formed so as to have a relation of a mirror-image centered on an imaginary surface that separates between the first movable contacting piece and the second movable contacting piece. It may be configured such that the operation tongue piece of the first movable contacting piece and the operation tongue piece of the second movable contacting piece are respectively operated by the pair of the plungers to respectively bring a first movable contact of the first movable contacting piece and a second movable contact of the second movable contacting piece into and out of contact with a first fixed contact and a second fixed contact.

According to the present embodiment, in addition to the foregoing effect, it is possible to obtain a push button switch capable of individually detecting two objects to be detected, while remaining small in size.

As another embodiment of the present invention, the foregoing first and second movable contacting pieces may be respectively disposed on both sides of the foregoing third movable contacting piece.

According to the present embodiment, it is possible to obtain a push button switch having a larger variety of detection patterns, while remaining small in size.

As a new embodiment of the present invention, the operation body may have an operation surface that smoothly slides on a surface of the operation tongue piece.

According to the present embodiment, an operation by the plunger provided with the operation body is smoothly performed, leading to improvement in operation feeling.

As a different embodiment of the present invention, the movable contacting piece may be bent in a substantially U-shape.

According to the present embodiment, since a distance between fulcrums of the movable contacting piece becomes long, a fatigue of the movable contacting piece due to stress is reduced to improve the durability.

As another embodiment of the present invention, the operation tongue piece may be bent so as to protrude toward the plunger.

According to the present embodiment, a sliding operation of the plunger is smoothly performed, enabling a smooth switching operation.

As another embodiment of the present invention, a pressing portion of the plunger may be on the same plane as a surface of the housing.

According to the present embodiment, the pressing portion of the plunger is less likely to be damaged by force, of impact from the outside, leading to improvement in design.

As a different embodiment of the present invention, the pair of the plungers may be formed so as to have a relation of a mirror-image centered on an imaginary surface that separates between the plungers.

According to the present embodiment, it is possible to obtain a push button switch which is easy to design and capable of performing a larger variety of operations.

As a new embodiment of the present invention, the pair of the movable contacting pieces may be formed so as have a relation of a mirror-image centered on an imaginary surface that separates between the movable contacting pieces.

According to the present embodiment, there is an effect of obtaining a push button switch which is easy to design and capable of performing a larger variety of operations.

### BRIEF DESCRIPTION OF DRAWINGS

FIG. 1 is an overall perspective view showing a first embodiment, of a push button switch according to the present invention.

FIG. 2 is an exploded perspective view of the push button switch shown in FIG. 1.

FIG. 3 is an exploded perspective view of the push button switch shown in FIG. 1, seen from a different angle.

FIG. 4 is a side sectional view of the push button switch shown in FIG. 1.

FIG. 5 is a side sectional view with first and second plungers erased from FIG. 4.

FIG. 6 is a side sectional view with a common fixed contact terminal erased from FIG. 5.

FIG. 7 is a horizontal sectional view of the push button switch shown in FIG. 1.

FIG. 8 is a horizontal sectional view of the push button switch cut off in a position different from FIG. 7.

FIG. 9 is a plan view with a cover erased from the push button switch shown in FIG. 1.

FIG. 10 is a partial enlarged view of FIG. 9.

FIG. 11 is a front sectional view of the push button switch shown in FIG. 1.

FIG. 12 is a partial enlarged view of FIG. 11.

FIG. 13 is an overall perspective view showing the middle of operation of the push button switch shown in FIG. 1.

FIG. 14 is a front sectional view of FIG. 13.

FIG. 15 is an overall perspective view showing a state after the operation of the push button switch shown in FIG. 1.

FIG. 16 is a front sectional view of FIG. 15.

FIG. 17 is an overall perspective view showing a state after a different operation of the push button switch shown in FIG. 1.

FIG. 18 is a partial enlarged perspective view with a cover erased from FIG. 17.

FIG. 19 is an overall perspective view showing a state after another operation of the push button switch shown in FIG. 1.

FIG. 20 is a side sectional view of FIG. 19.

FIG. 21 is a perspective view with the cover erased from FIG. 19.

FIG. 22 is a partial enlarged perspective view of FIG. 21.

FIG. 23 is a perspective view showing a mounted state of the push button switch shown in FIG. 1.

FIG. 24 is a side sectional view of FIG. 23.

FIG. 25 is a front sectional view of FIG. 23.

FIG. 26 is an overall perspective view showing a second embodiment of the push button switch according to the present invention.

FIG. 27 is an exploded perspective view of the push button switch shown in FIG. 26.

FIG. 28 is an exploded perspective view of the push button switch shown in FIG. 26, seen from a different angle.

FIG. 29 is a plan view with a cover erased from the push button switch shown in FIG. 26.

FIG. 30 is a partial enlarged view of FIG. 26.

FIG. 31 is an overall perspective view showing a third embodiment of the push button switch according to the present invention.

FIG. 32 is an exploded perspective view of the push button switch shown in FIG. 31.

FIG. 33 is an exploded perspective view of the push button switch shown in FIG. 31, seen from a different angle.

FIG. 34 is a plan view with a cover erased from the push button switch shown in FIG. 31.

FIG. 35 is a partial enlarged view of FIG. 34.

FIG. 36 is a time chart showing opening and closing operations of an electromagnetic relay according to the first, second, and third embodiments.

FIG. 37 is an overall perspective view showing a fourth embodiment of the push button switch according to the present invention.

FIG. 38 is a front sectional view of FIG. 37.

FIG. 39 is an overall perspective view showing the middle of operation of the push button switch shown in FIG. 37.

FIG. 40 is a front sectional view of FIG. 37.

FIG. 41 is an overall perspective view showing a FIG. 37.

FIG. 42 is a front sectional view of FIG. 41.

FIG. 43 is an exploded perspective view of the push button switch shown in FIG. 37.

FIG. 44 is an exploded perspective view of the push button switch shown in FIG. 37, seen from a different angle.

FIG. 45 is a plan view with a cover erased from the push button switch shown in FIG. 37.

FIG. 46 is a partial enlarged view of FIG. 45.

### DESCRIPTION OF EMBODIMENTS

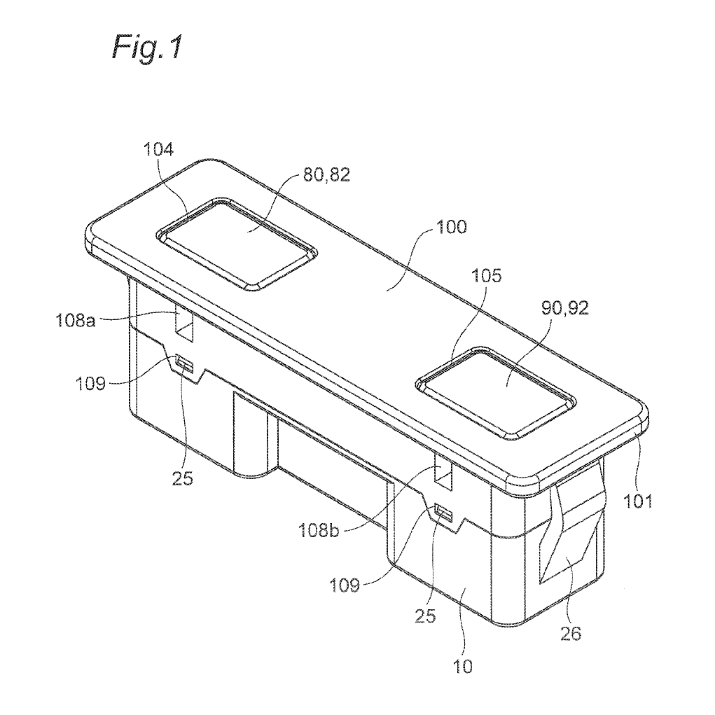

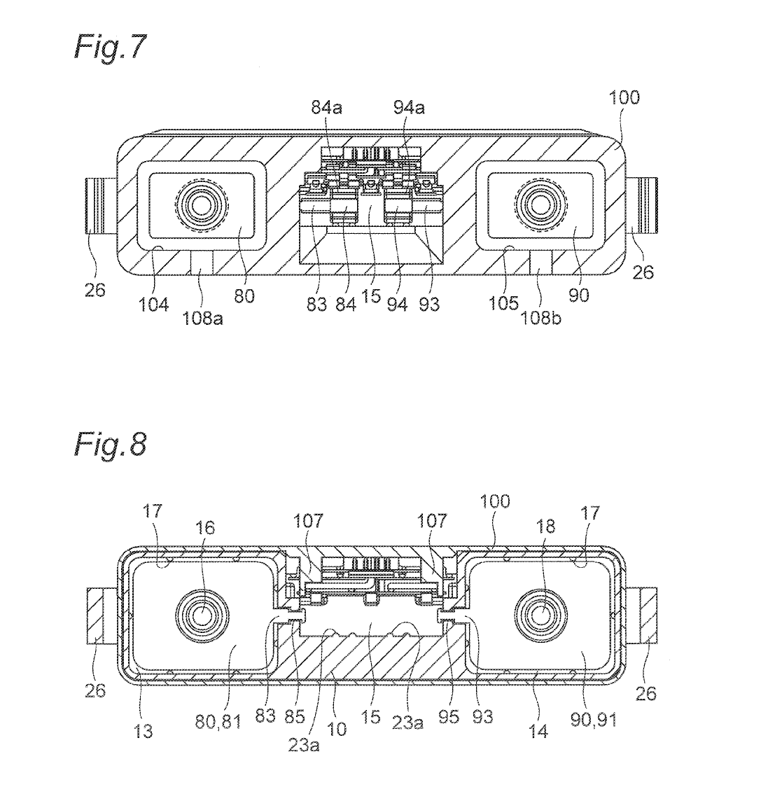

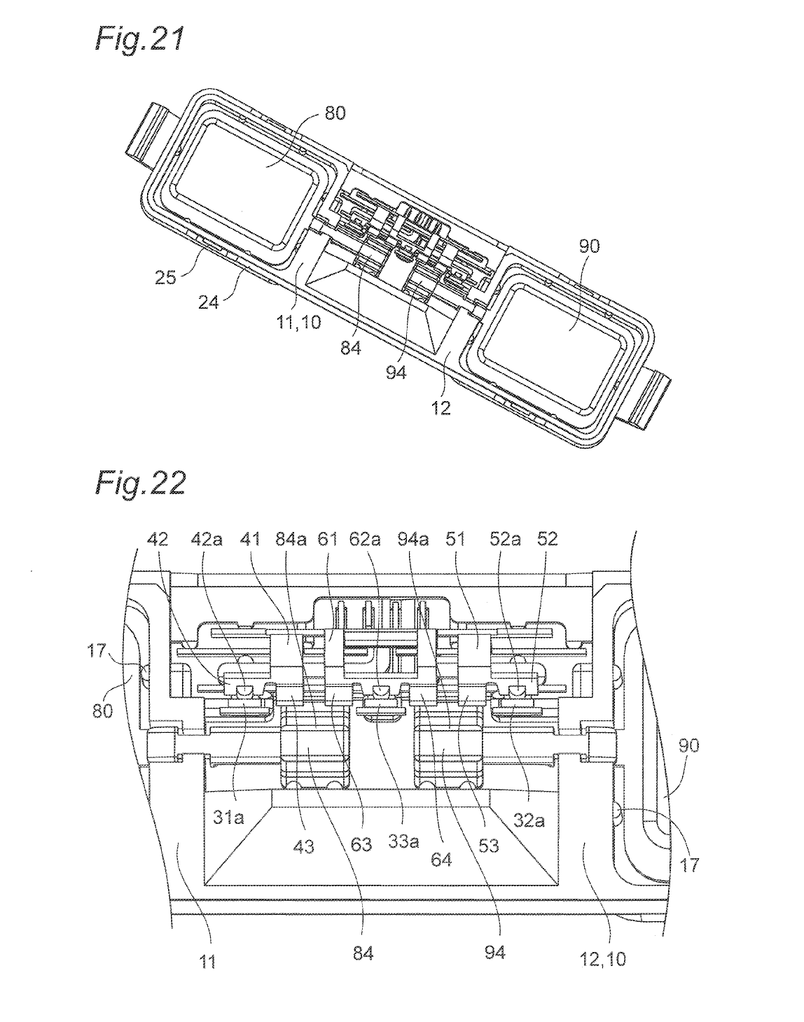

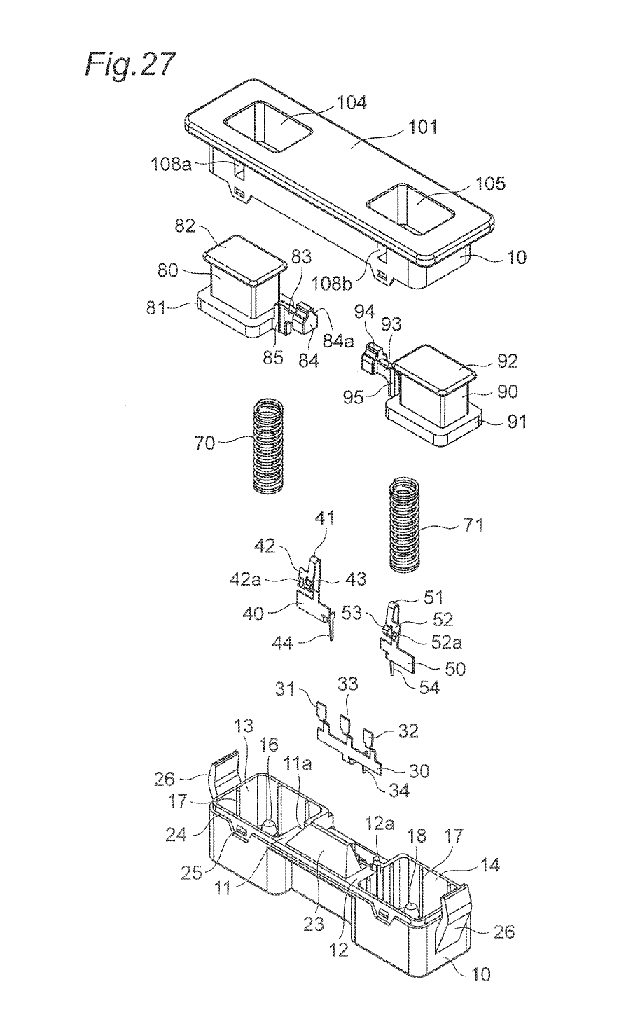

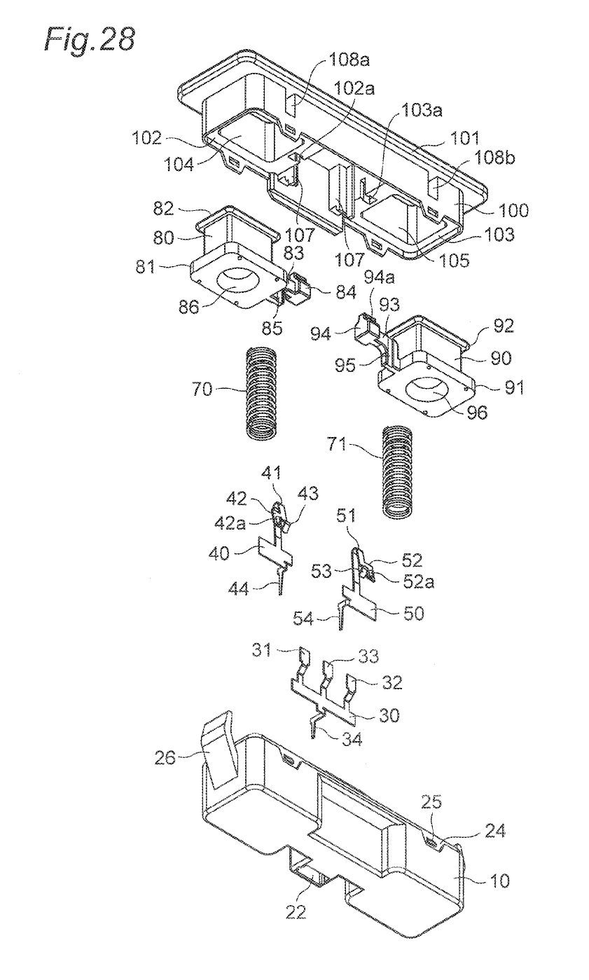

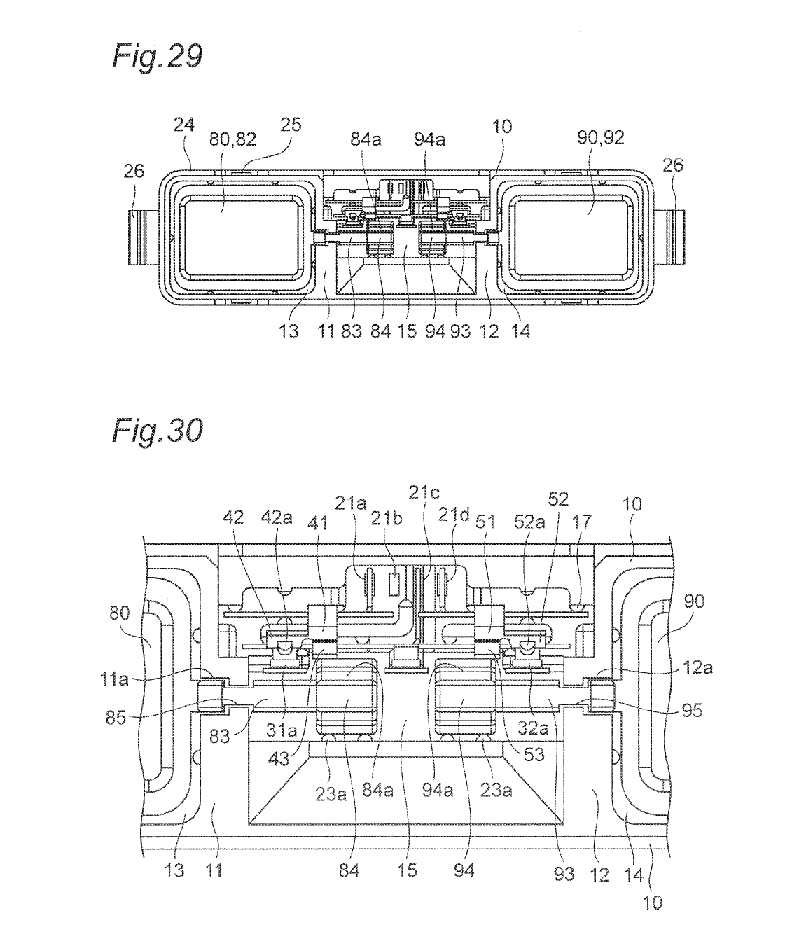

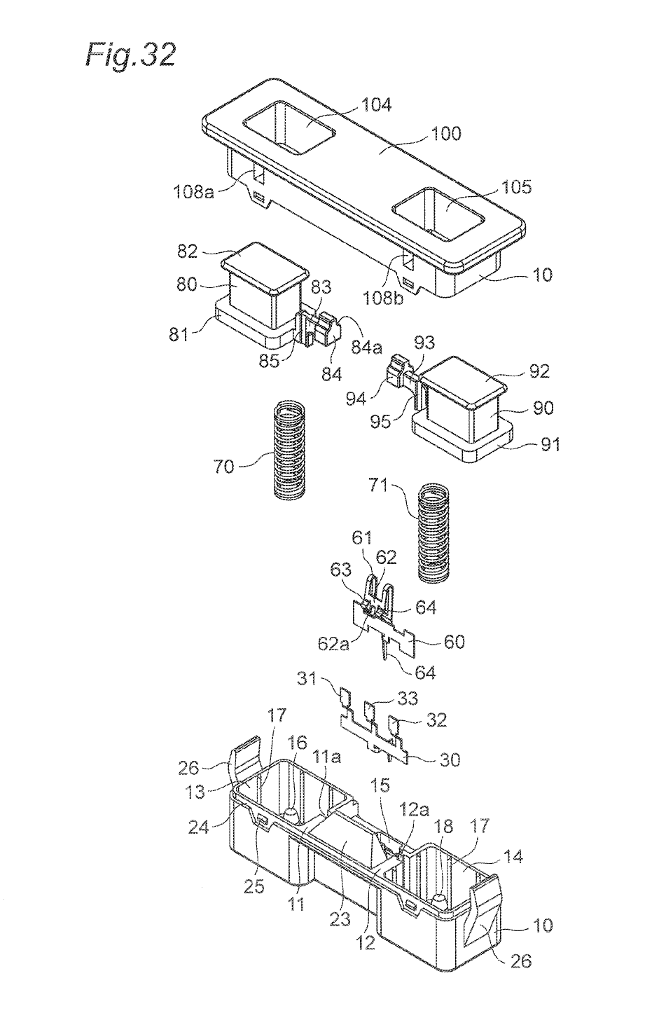

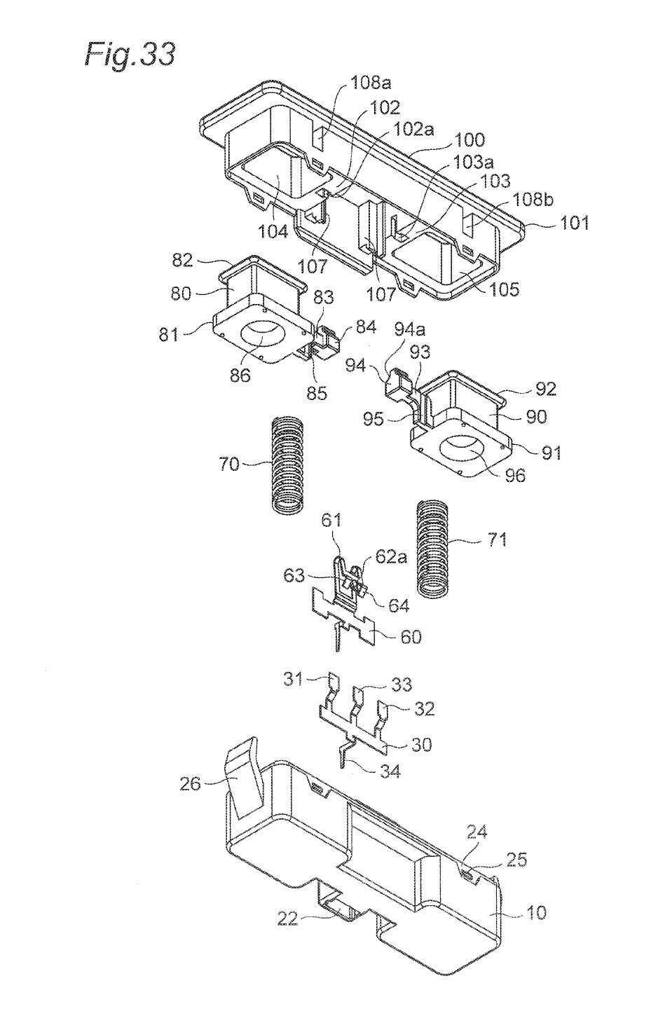

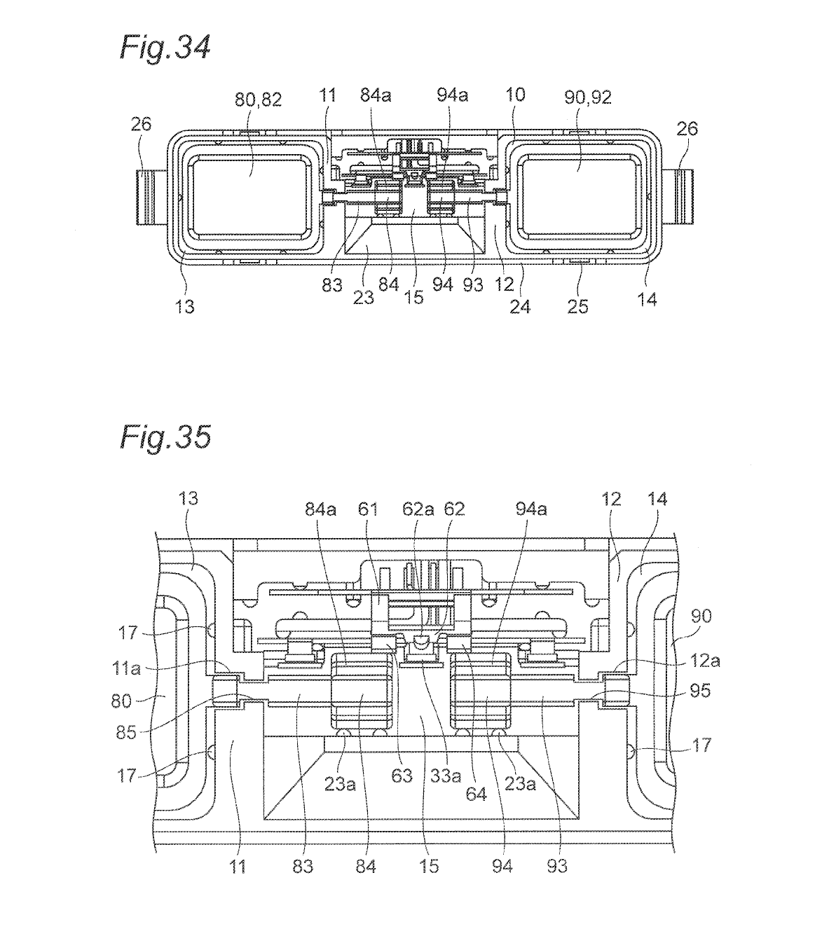

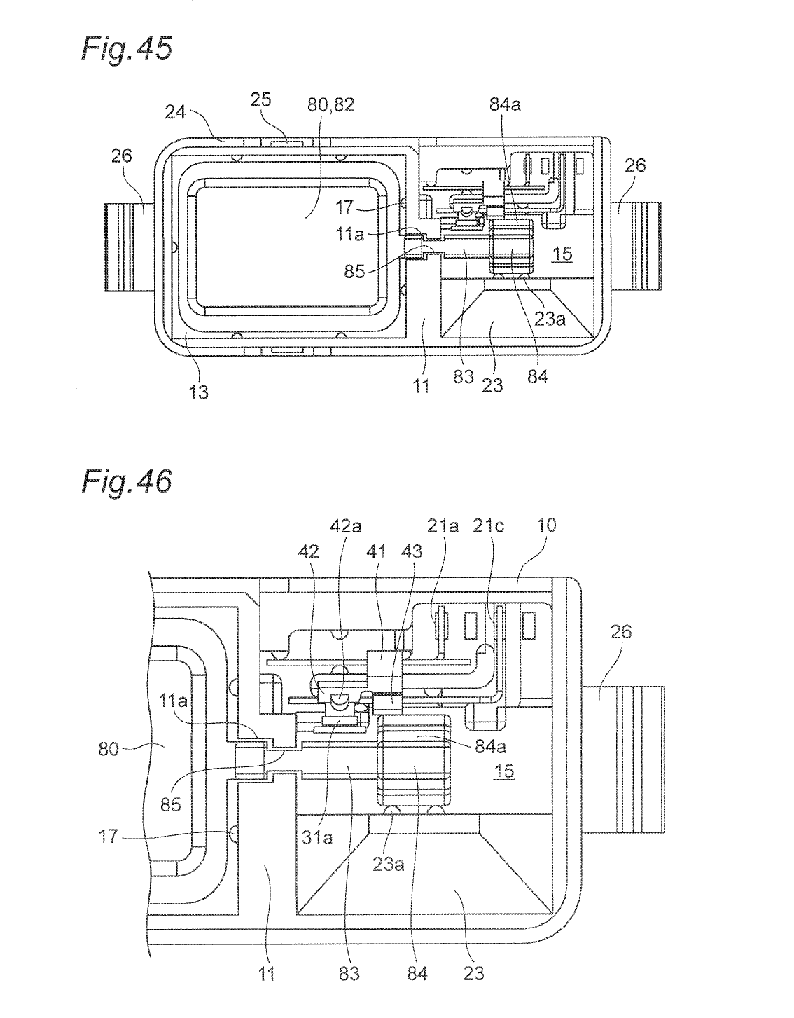

Embodiments of a push button switch according to the present invention are described based on FIGS. 1 to 46.

As shown in FIGS. 1 to 25, a first embodiment is a push button switch mounted on a refrigerator-freezer having double doors, for example. The push button switch can detect four kinds of opening and closing states: a state where only a left door is closed; a state where only a right, door is closed; a state where the right and left doors are simultaneously closed; and a state where the right and left doors are simultaneously open.

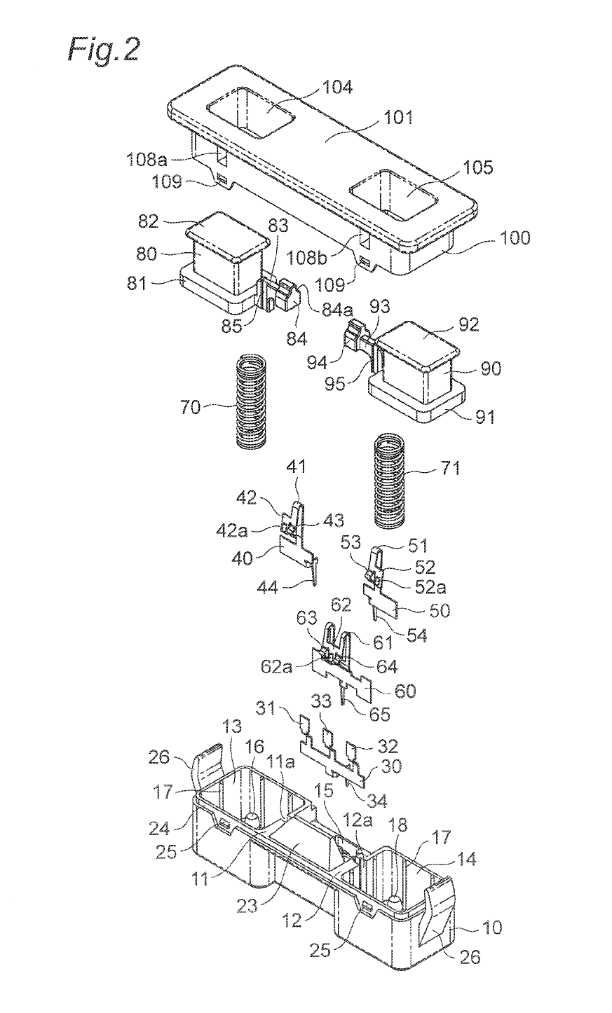

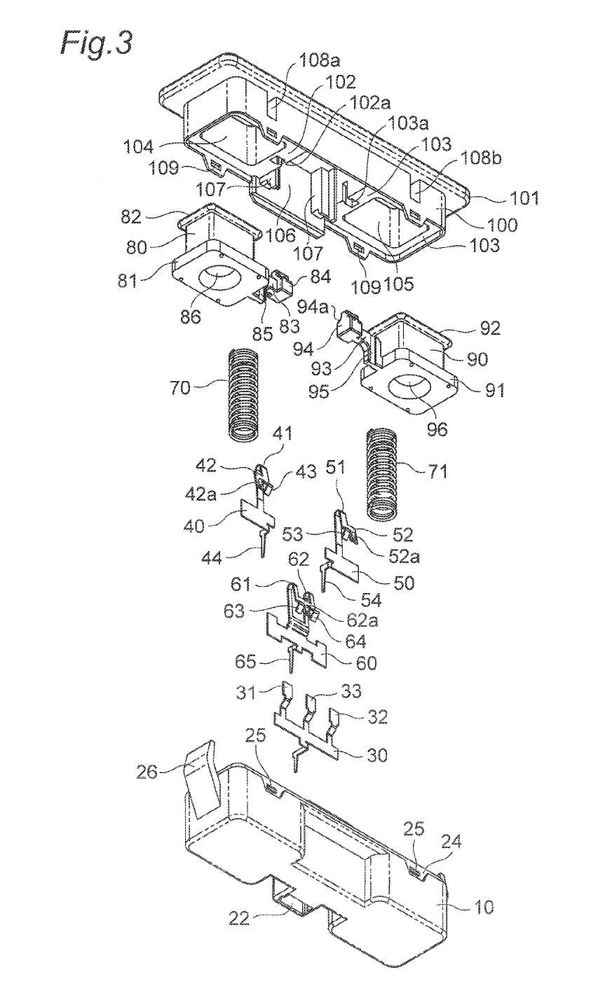

As shown in FIGS. 2 and 3, the push button switch is roughly composed of a base 10, a common fixed contact terminal. 30, first and second movable contact terminals 40, 50, a third movable contact terminal 60, first and second return springs 70, 71, first and second plungers 80, 90, and a cover 100.

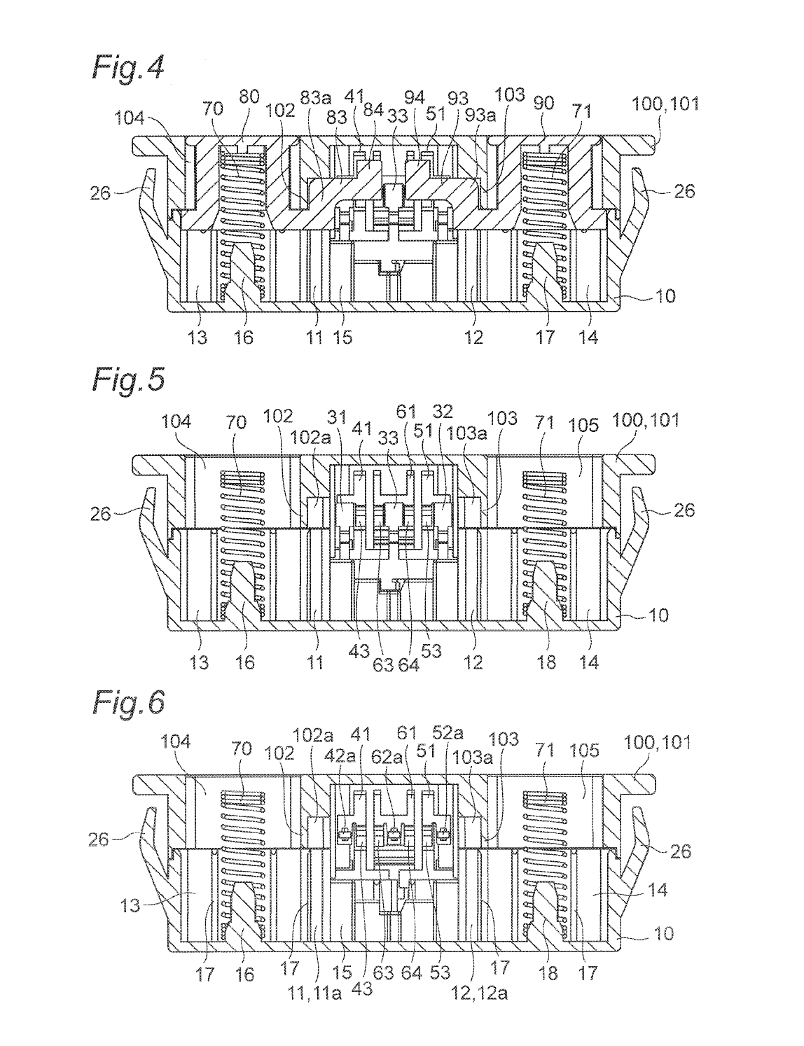

The base 10 has a flat rectangular boxed-shape, and is separated into three recesses of first, second, and third recesses 13, 14, 15 (FIG. 4) by two partition walls 11, 12 that projects on the bottom of the base 10. The partition walls 11, 12 are respectively provided with guide grooves 11a, 12a (FIG. 2) for communicating the adjacent first, second, and third recesses 13, 14, 15.

At the bottom center of the first recess 13, a support projection 16 is projected for supporting the first return spring 70 described later. Further, on the inner peripheral surface of the first recess 13, a positioning rib 17 is provided. The positioning rib 17 is provided so as to make frictional resistance small at the time when the first plunger 80 described later slides, and to prevent occurrence of wobbling.

Also in the second recess 14, as in the first recess 13, a support projection 18 and the positioning rib 17 are provided.

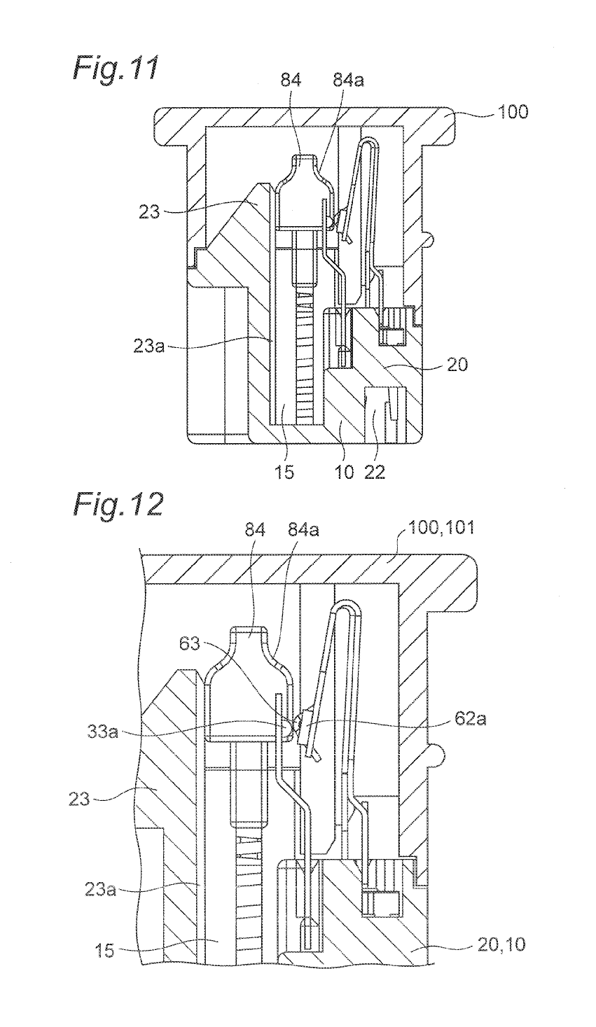

In the third recess 15, four terminal holes 21a, 21b, 21c, 21d (FIG. 10) are provided on a step 20 (FIG. 11) provided at the rear-side corner out of the facing corners of the bottom and located one level higher than the bottom, to form a connector 22. Further, in the third recess 15, a protrusion 23 is formed along the inner peripheral surface facing the step 20, and a positioning rib 23a is provided so as to be vertically along with the protrusion 23.

A fitting step 24 is provided along the outer-peripheral edge of an opening of the base 10, and engaging hook portions 25 are provided in the fitting step 24. Further, the short-side outer side surfaces of the base 10 are respectively provided with elastic hook portions 26, 26.

Along the upper-side edge of the common fixed contact terminal 30, first, second, and third fixed contact pieces 31, 32, 33 are provided at predetermined pitches. The inner surfaces of the first, second, and third fixed contact pieces 31, 32, 33 are respectively provided with first, second, and third fixed contacts 31a, 32a, 33a (FIG. 10). A terminal portion 34 of the common fixed contact terminal 30 is then pressed into the terminal hole 21c of the base 10 and fixed in the terminal hole 21c.

The first movable contact terminal 40 has a movable contacting piece 41 bent in a substantially U-shape. A movable contact piece 42 and an operation tongue piece 43 are provided at the free end of the movable contacting piece 41 and coupled with each other so as to rotate integrally. A movable contact 42a is provided in the movable contact piece 42. A terminal portion 44 of the first movable contact terminal 40 is then pressed into the terminal hole 21a provided in the base 10 and fixed in the terminal hole 21a.

The second movable contact terminal 50 is formed so as to have the relation of a mirror-image centered on an imaginary surface that separates between the first movable contact terminal 40 and the second movable contact terminal 50. That is, both movable contact terminals have three-dimensional shapes that cannot be superimposed on each other like a right hand and a left hand. Thus, similarly to the first movable contact terminal 40, the second movable contact terminal 50 has a movable contacting piece 51 bent in a substantially U-shape. A movable contact piece 52 and an operation tongue piece 53 are provided at the free end of the movable contacting piece 51 and coupled with each other so as to rotate integrally. A movable contact 52a is provided in the movable contact piece 52. A terminal portion 54 of the second movable contact terminal 50 is then pressed into the terminal hole 21d provided in the base 10 and fixed in the terminal hole 21d.

A movable contacting piece 61 bent in a substantially U-shape is extended from the upper-side edge of the third movable contact terminal 60. Operation tongue pieces 63, 64 are respectively disposed on both sides of a movable contact piece 62 extended from the free end of the movable contacting piece 61, and coupled with each other so as to rotate integrally. A terminal portion 65 of the third movable contact terminal 60 is then pressed into tine terminal hole 21b provided in the base 10 and fixed in the terminal hole 21b.

The first and second return springs 70, 71 are provided so as to apply spring forces for returning the first and second plungers 80, 90 described later to the original positions. The first and second return springs 70, 71 are then inserted respectively through the support projections 16, 18 of the base 10 to be positioned.

The lower end of the first plunger 80 is provided with a flange portion 81 capable of sliding in the first recess 13 of the base 10. The upper end of the first plunger 80 is provided with a pressing portion 82. Further, in the first plunger 80, an operation arm portion 83 bent at substantially a right angle is extended from the inner surface of the flange portion 81. The free end of the operation arm portion 83 is integrally molded with an operation body 84, and a base portion of the operation arm portion 83 is provided with a guide groove 85. As shown in FIG. 2, the operation body 84 has a substantially trapezoidal shape in a front view, and has an operation surface 84a on one side surface thereof. The operation surface 84a is a taper surface for smoothly operating the operation tongue pieces 43, 63. Note that the shape of the operation surface 84a is not necessarily limited to this shape, but may be the shape of an arc surface such as a parabolic shape, and can naturally be selected from a variety of shapes as necessary. Further, a housing hole 86 is provided on the bottom surface of the first plunger 80 (FIG. 3).

By housing the first return spring 70 in the housing hole 86 of the first plunger 80, the first plunger 80 is biased upward by the spring force of the first return spring 70.

The second plunger 90 is formed, so as to have the relation of a mirror-image centered on an imaginary surface that separates between the first plunger 80 and the second plunger 90. That is, both movable contact terminals have three-dimensional shapes that cannot be superimposed on each other like a right hand and a left hand. Thus, similarly to the first plunger 80, the lower end of the second plunger 90 is provided with a flange portion 91 capable of sliding in the second recess 14 of the base 10. The upper end of the second plunger 90 is provided with a pressing portion 92. Further, in the second plunger 90, an operation arm portion 93 bent at substantially a right angle is extended from the inner surface of the flange portion 91. The free end of one operation arm portion 93 is integrally molded with an operation body 94, and a base portion of the operation arm portion 93 is provided with a guide groove 95. As shown in FIG. 3, the operation body 94 has a substantially trapezoidal shape in a front view, and has an operation surface 94a on one side surface thereof. The operation surface 94a is a taper surface for smoothly operating the operation tongue pieces 64, 53. Note that the shape of the operation surface 94a is not necessarily limited to this shape, but may be the shape of an arc surface such as a parabolic shape, and can naturally be selected from a variety of shapes as necessary. Further, a housing hole 96 is provided on the bottom surface of the second plunger 90.

By housing the second return spring 71 into the housing hole 96 of the second plunger 90, the second plunger 90 is biased upward by the spring force of the second return spring 71.

The cover 100 has a boxed-shape with a flat surface that can be fitted to the base 10. A face plate 101 is integrally molded with the upper surface of the cover 100, and a pair of operation holes 104, 105 is formed by a pair of annular partition walls 102, 103. Hence the cover 100 is separated into three spaces, namely the operation holes 104, 105 and a center recess 106 (FIG. 3), by the annular partition walls 102, 103.

The cover 100 has guide grooves 102a, 103a provided on the inner surface which faces the annular partition walls 102, 103. The guide grooves 102a, 103a are respectively continued to the guide grooves 11a, 12a of the base 10. Retaining ribs 107, 107 are provided at corners of the center recess 106. Further, drain holes 108a, 108b that communicate with the operation holes 104, 105 are provided on one long-side side surface of the cover 100. Engaging holes 109 to be engaged with the engaging hook portions 25 of the base 10 are provided along the lower opening edge of the cover 100.

Next, an assembly procedure is described.

The terminal portion 44 of the first movable contact terminal 40, the terminal portion 65 of the third movable contact terminal 60, the terminal portion 34 of the common fixed contact terminal 30, and the terminal portion 54 of the second movable contact terminal 50 are respectively pressed into the terminal holes 21a, 21b, 21c, 21d of the base 10. When the common fixed contact terminal 30 and the first, second, and third movable contact terminals 40, 50, 60 are assembled onto the base 10, by spring forces of the movable contacting pieces 41, 51, 61 of their owns, the movable contacts 42a, 52a, 62a come into contact with the first, second, and. third fixed contacts 31a, 32a, 33a at respective predetermined pressures.

The first and second return springs 70, 71 are then inserted through the support projections 16, 18 of the base 10.

Meanwhile, the first and second plungers 80, 90 are assembled into the operation holes 104, 105 of the cover 100 from the lower side. The first and second return springs 70, 71 are then assembled so as to be housed in the housing holes 86, 96 of the first and second plungers 80, 90, and the engaging holes 109 of the cover 100 are engaged with the engaging hooks portion 25 of the base 10, to complete the assembly operation.

At this time, the operation body 84 of the first plunger 80 presses the operation tongue piece 43 of the first movable contact terminal 40 and the operation tongue piece 63 of the third movable contact terminal 60. Further, the operation body 94 of the second plunger 90 presses the operation tongue piece 53 of the second movable contact terminal 50 and the operation tongue piece 64 of the third movable contact terminal 60. Accordingly, while the movable contact 42a is separated from the first fixed contact 31a and the movable contact 52a is separated from the second fixed contact 32a, the movable contact 62a is separated from the third fixed contact 33a.

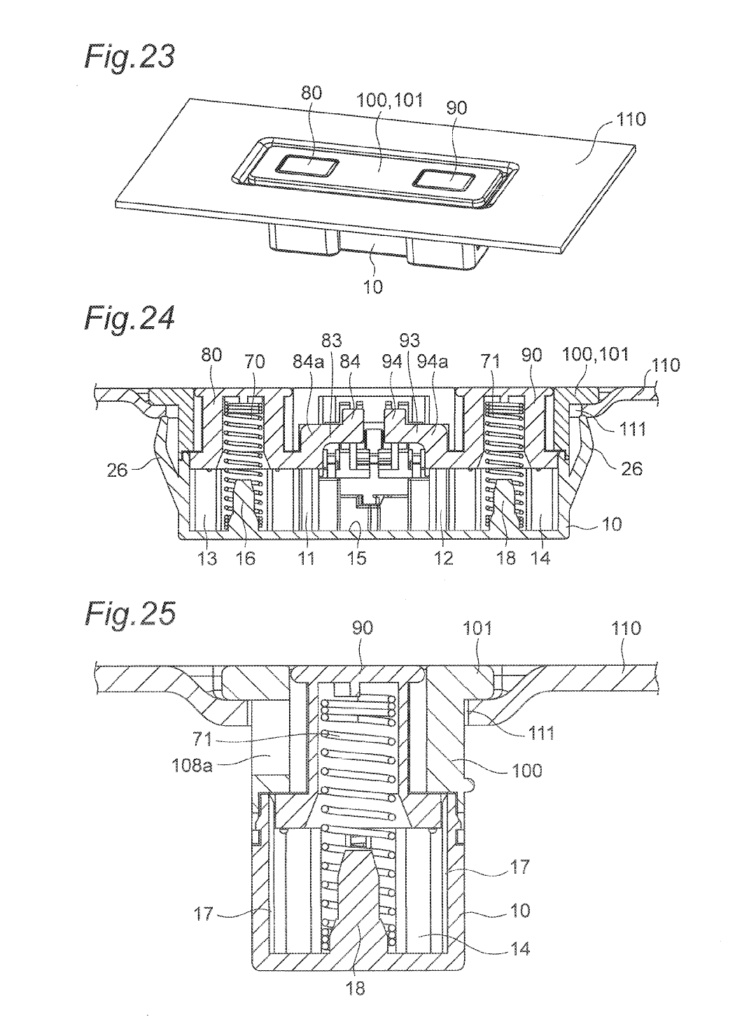

Note that as shown in FIGS. 23 to 25, by inserting the push button switch from the base 10 side into the mounting hole 111 of the mounting plate 110, the elastic hook portions 26 are elastically transformed inward and then elastically returned. The opening edge of the mounting hole 111 of the mounting plate 110 is held between the elastic hook portions 26 and the face plate 101 of the cover 100, to retain the push button switch.

In particular, in the present embodiment, the opening edge of the mounting hole 111 is located one level lower. Thus, even when the push button switch is mounted, the surface of the face plate 101 is flush with the surface of the mounting plate 110. This results in a lowered possibility of force of impact from, the outside to act on the push button switch, and hence the push button is advantageous not only in being hardly damaged, but also in being beautiful in terms of design.

Further, even in use for a refrigerator or the like, the push button switch has such a waterproof structure as described below for preventing a short circuit and a return defect by preventing entry of a water drop and food juice.

That is, the space in which the first and second plungers 80, 90 are housed and the space in which the common fixed contact terminal 30 and the like are housed are separated by the partition walls 11, 12 of the base 10 and the annular partition walls 102, 103 of the cover 100. Hence it is possible to prevent entry and adhesion of a water drop, food juice, and the like from the outside into the space in which the common fixed contact terminal 30 and the like are disposed.

The common fixed contact terminal 30 and the like are assembled onto the step 20 that is one level higher than the bottom of the base 10. Thus, even if food juice enters the third recess 15 of the base 10, it hardly adheres to the first, second, and third fixed contacts 31a, 32a, 33a.

When the first and second plungers 80, 90 have been returned to the return positions, by the spring forces of the first and second return springs, the base portions of the operation arm portions 83, 93 are pressed and contacted onto the lower ends of the annular partition walls 102, 103 of the cover 100. This can effectively prevent entry of water and the like.

Further, the outer peripheral edges of the pressing portions 82, 92 of the first and second plungers 80, 90 are arc surfaces, and linearly in contact with the inner surfaces of the operation holes 104, 105 of the cover 100. This can prevent entry of water drops and food juice. In particular, there is an advantage in that, even when food juice is accumulated and solidified in gaps between the pressing portions 82, 92 and the operation holes 104, 105, the solidified state is destroyed as accompanied by the opening and closing operation of the switch, and a normal operation is performed.

The cover 100 is then provided with drain holes 108a, 108b that communicate with the operation holes 104, 105. Thus, even when water or the like enters the operation holes 104, 105, the water or the like can be drained to the outside via the drain holes 108a, 108b and prevented from entering deep inside.

Moreover, the operation arm portions 83, 93 of the first and second plungers 80, 90 are bent in a substantially L-shape. Hence the water having entered the operation holes 104, 105 do not get deep inside through the operation arm portions 83, 93. In particular, as shown in FIGS. 4 and 5, corner portions 83a, 93a of the operation arm portions 83, 93 are respectively fitted with the guide grooves 102a, 103a of the cover 100, thus leading to an advantage that a creeping distance becomes long and the entry of water or the like is more unlikely.

Next, a method for operating the push button switch is described.

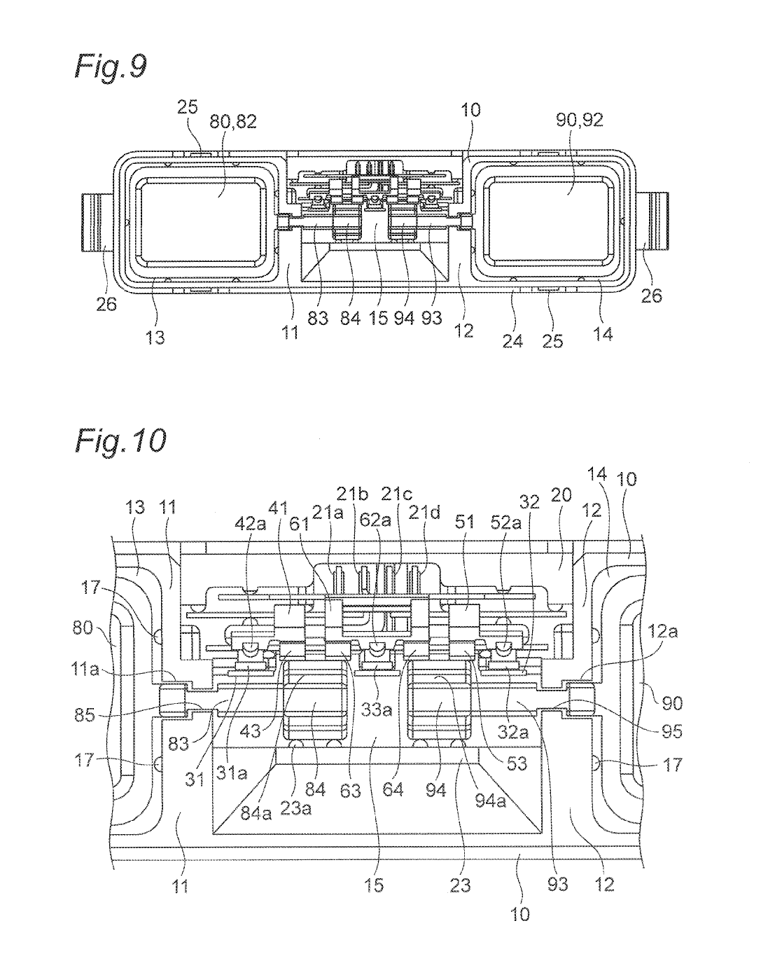

First, when the first and second plungers 80, 90 are in returned positions before the operation, as shown in FIGS. 9 and 10, the operation surface 84a of the operation body 84 of the first plunger 80 presses the operation tongue piece 43 of the movable contacting piece 41 and the operation tongue piece 63 of the movable contacting piece 61. Further, the operation surface 94a of the operation body 94 of the second plunger 90 presses the operation tongue piece 53 of the second movable contact terminal 50 and the operation tongue piece 64 of the third movable contact terminal 60. Hence the movable contacts 42a, 52a, 62a are respectively separated from the first, second, and third fixed contacts 31a, 32a, 33a.

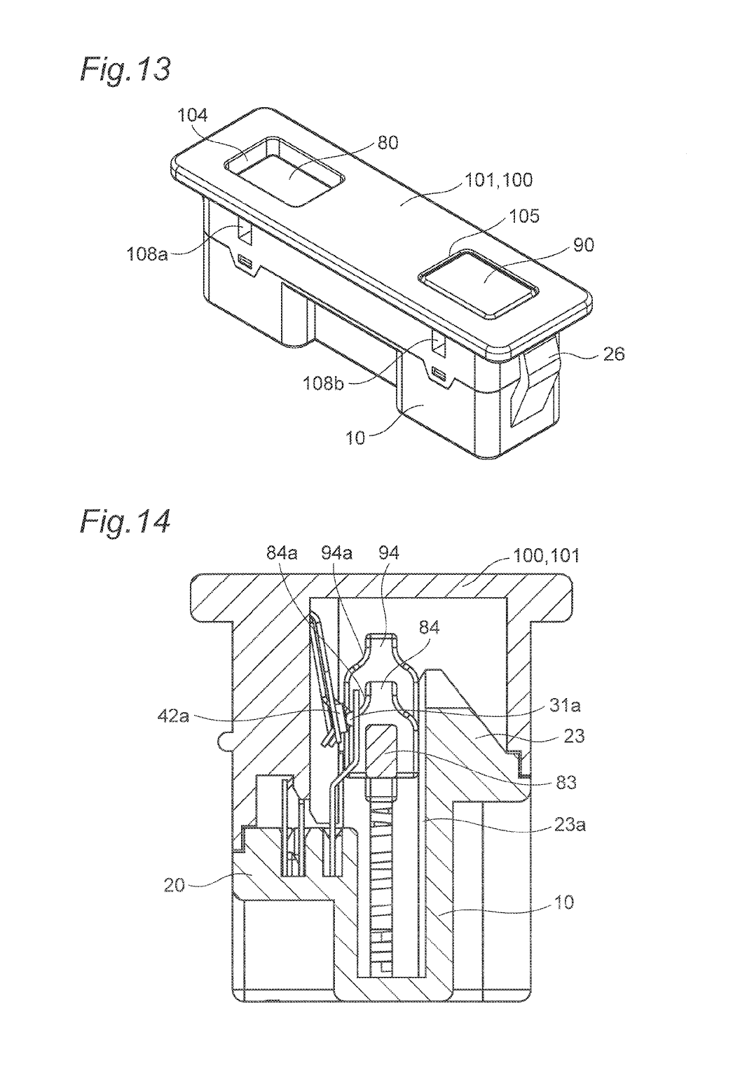

Then, as shown in FIGS. 13 and 14, when only the first plunger 80 is pushed down, the operation body 84 is lowered and the operation surface 84a slides on the surface of the operation tongue piece 43, to reduce a load on the operation tongue piece 43. Hence the movable contacting piece 41 is elastically returned, and the movable contact 42a comes into contact with the first fixed contact 31a. In short, the movable contact 42a of the movable contacting piece 41 is displaced vertically to the pushing-in direction of the first plunger 80.

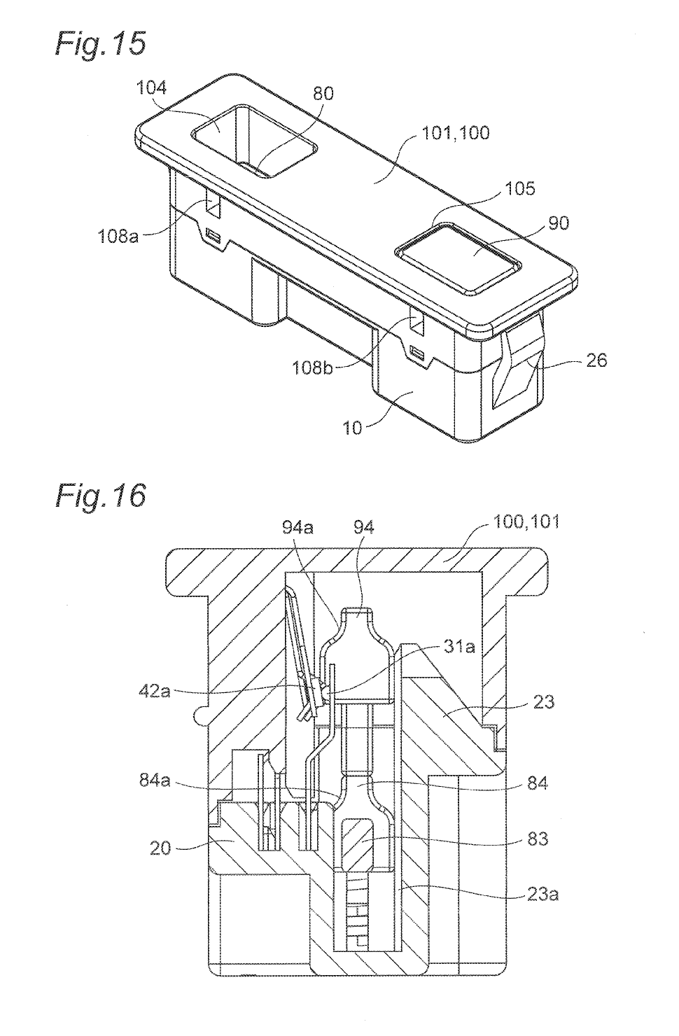

As shown in FIGS. 15 and 16, when the first plunger 80 is further pushed down, the operation surface 84a of the operation body 84 is separated from the operation tongue piece 43, and no load is then applied on the operation tongue piece 43. The movable contact 42a comes into contact with the first fixed contact 31a with predetermined pressure.

Since the position of the operation tongue piece 64 in the movable contacting piece 61 of the third movable contact terminal 60 is regulated by the operation body 94 of the second plunger 90, the movable contact 62a does not come into contact with the third fixed contact 33a.

When the push-down operation on the first plunger 80 is released, the first plunger 80 is pushed back by spring force of the first return spring 70, and returned to the original position. Hence the operation body 84 rises, the operation surface 84a pushes back the operation tongue piece 43, and the movable contact 42a is separated from the first fixed contact 31a.

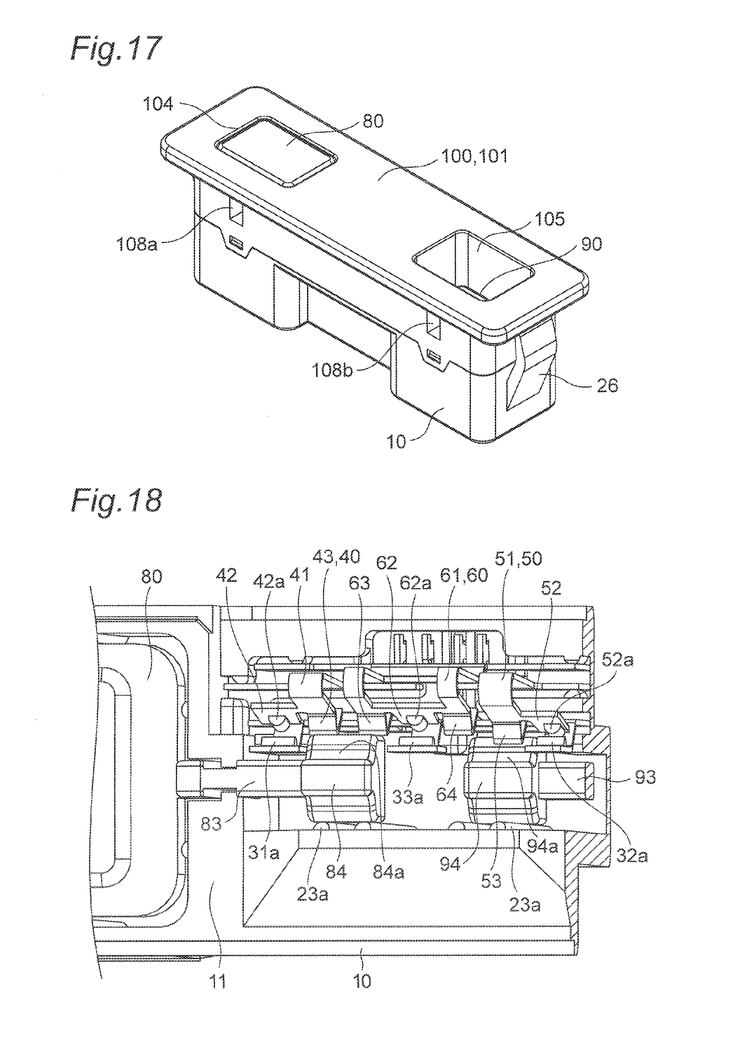

Then, as shown in FIGS. 17 and 18, when only the second plunger 90 is pushed down, the operation body 94 is lowered and the operation surface 94a slides on the surface of the operation tongue piece 53, to reduce a load on the operation tongue piece 53. Hence the movable contacting piece 51 is elastically returned, and the movable contact 52a comes into contact with the second fixed contact 32a. In short, the movable contact 52a of the movable contacting piece 51 is displaced vertically to the pushing-in direction of the second plunger 90.

When the second plunger 90 is further pushed down, the operation surface 94a of the operation body 94 is separated from the operation tongue piece 53. As shown in FIG. 18, no load is then applied on the operation tongue piece 53 from the operation body 94, and the movable contact 52a comes into contact with the second fixed contact 32a with predetermined pressure.

Since the position of the operation tongue piece 63 in the movable contacting piece 61 of the third movable contact terminal 60 is regulated by the operation body 84 of the first plunger 80, the movable contact 62a does not come into contact with the third fixed contact 33a.

When the push-down operation on the second plunger 90 is released, the second plunger 90 is pushed back by spring force of the second return spring 71, and returned to the original position. Hence the operation body 94 rises, the operation surface 94a pushes back the operation tongue piece 53, and the movable contact 52a is separated from the second fixed contact 32a.

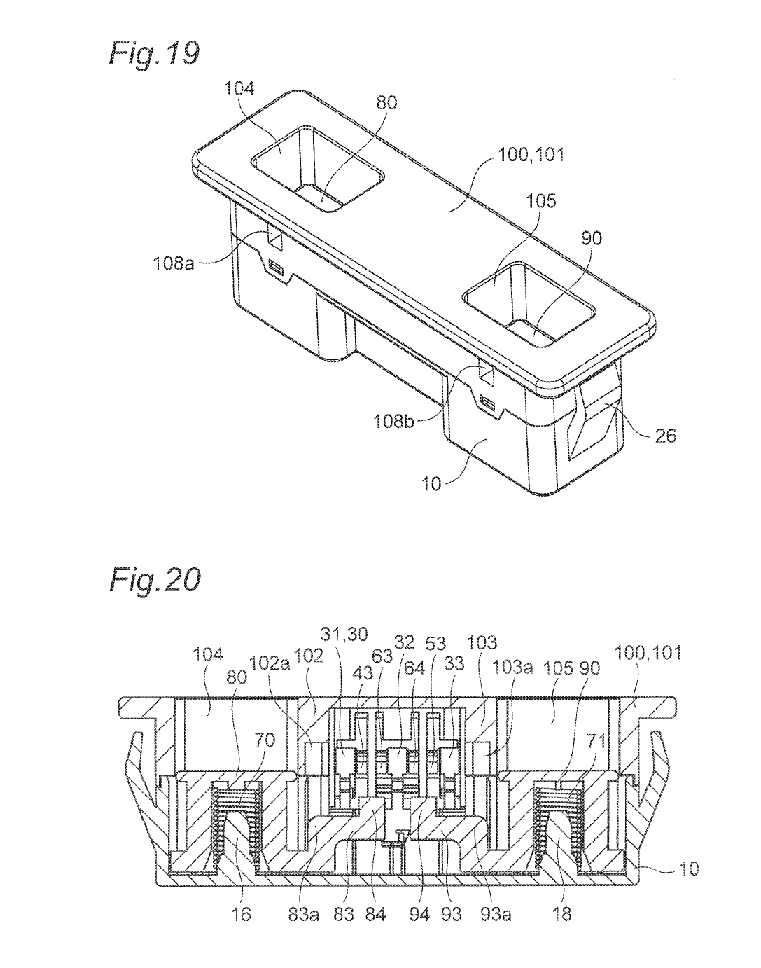

Then, as shown in FIGS. 19 and 22, when the first and second plungers are simultaneously pushed down, the operation bodies 84, 94 are lowered and the operation surface 84a slides on the surfaces of the operation tongue pieces 43, 63, while the operation surface 94a slides on the surfaces of the operation tongue pieces 64, 53, to reduce loads on the operation tongue pieces 43, 63, 64, 53. Hence the movable contacting pieces 41, 61, 51 are elastically returned, and the movable contacts 42a, 62a, 52a respectively come into contact with the first, third, and second fixed contacts 31a, 33a, 32a.

Further, when the first and second plungers 80, 90 are further pushed down, the operation surfaces 84a, 94a of the operation bodies 84, 94 are separated from the operation tongue pieces 43, 63, 64, 53, and no load is then applied on the movable contacting pieces 41, 61, 51 from the operation bodies 84, 94. The movable contacts 42a, 62a, 52a respectively come into contact with the first, third, and second fixed contacts 31a, 33a, 32a with predetermined pressures.

When the push-down operations on the first and second plungers 80, 90 are released, the first and second plungers 80, 90 are pushed back by the spring forces of the first and second return springs 70, 71, and returned to the original positions. Hence the operation bodies 84, 94 rise, the operation surfaces 84a, 94a respectively push back the operation tongue pieces 43, 53 and the operation tongue pieces 63, 64, and the movable contacts 42a, 62a, 52a are respectively separated from, the first, third, and second fixed contacts 31a, 33a, 32a.

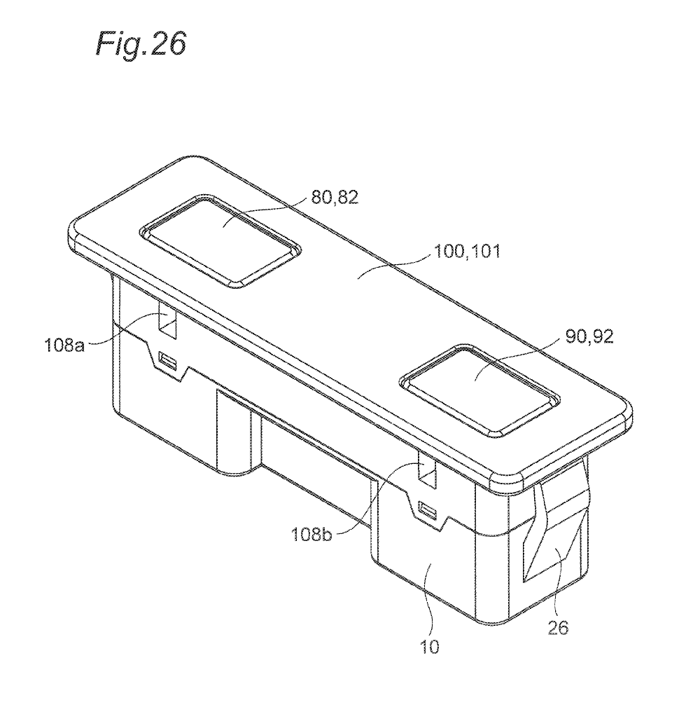

A second embodiment has the same basic structure as that of the foregoing first, embodiment except that the third movable contact terminal 60 is not incorporated as shown in FIGS. 26 to 30. Since the others are similar to those in the foregoing first embodiment, the same numerals are provided to the same portions and descriptions thereof are omitted.

According to the present embodiment, only by operating the first and second plungers 80, 90, it is possible to obtain a push button switch with the movable contacts 42a, 52a respectively coming into contact with the first and second fixed contacts 31a, 3a.

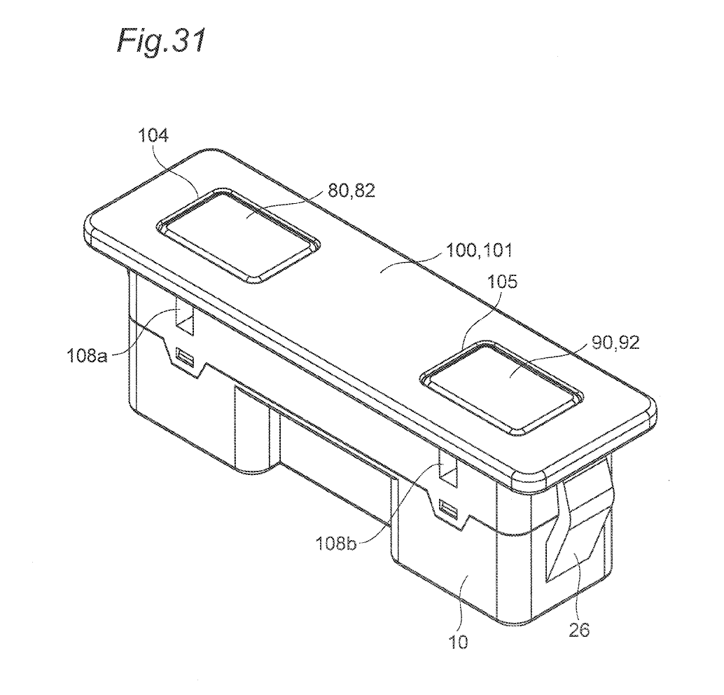

A third, embodiment has the same basic structure as that of the foregoing first embodiment except that the first and second movable contact terminals 40, 50 are not incorporated as shown in FIGS. 31 to 35. Since the others are similar to those in the foregoing first embodiment, the same numerals are provided to the same portions and descriptions thereof are omitted.

According to the present embodiment, only when the first and second plungers 80, 90 are simultaneously operated, it is possible to obtain a push button switch with the movable contact 62a coming into contact with the third fixed contact 33a.

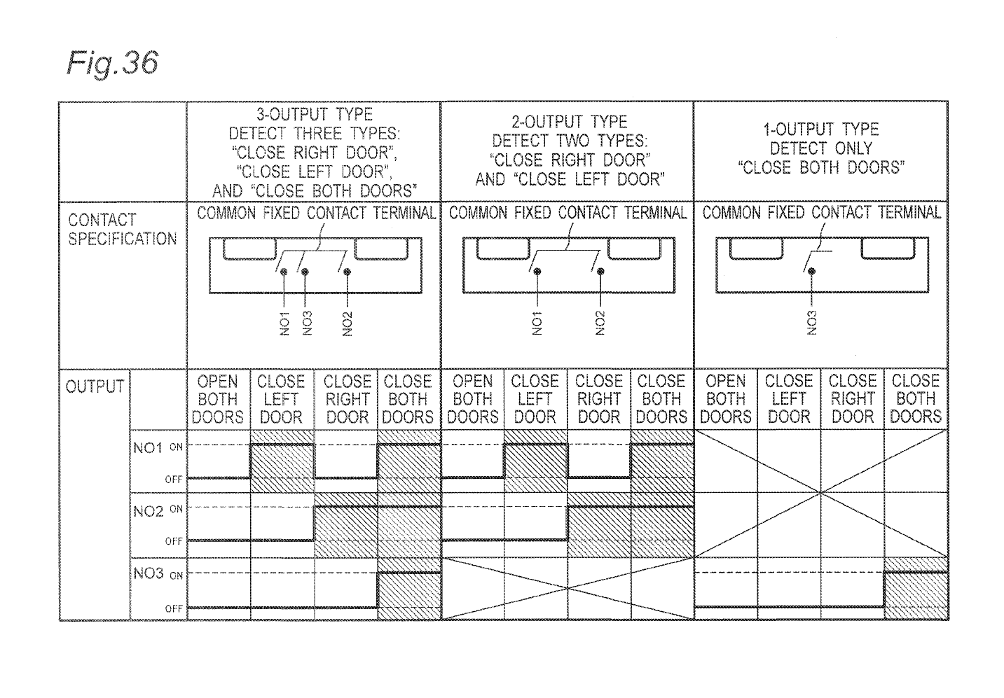

In order to facilitate understanding of the foregoing operation process, FIG. 36 shows a time chart summarizing the case of applying the push button switch to a refrigerator-freezer with double doors and detecting opening and closing of the double doors.

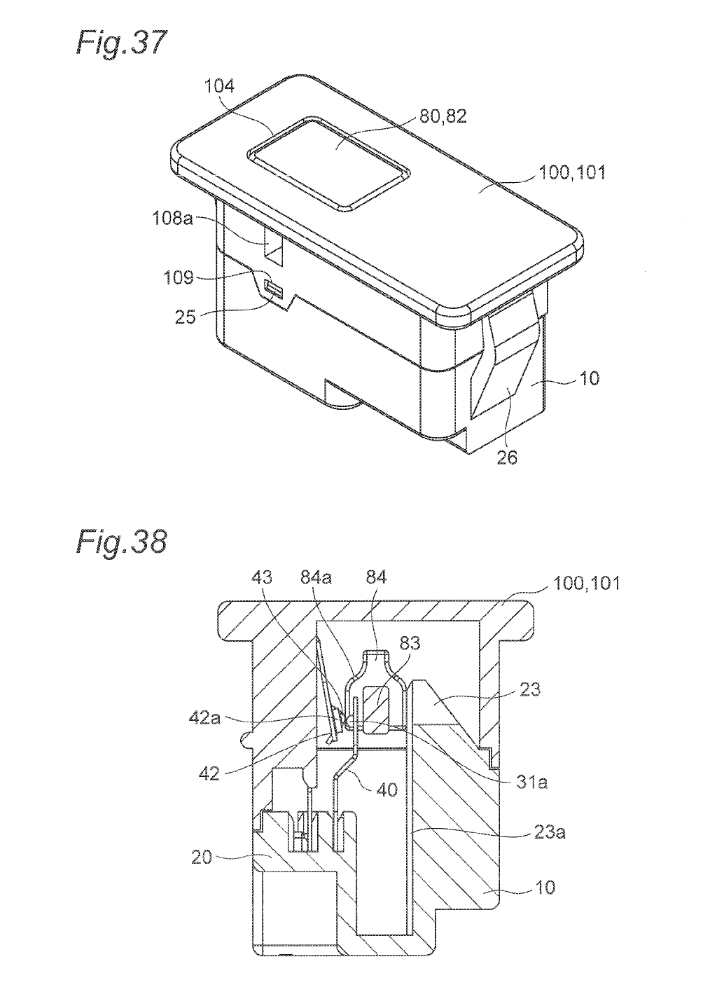

A fourth embodiment is a push button switch having only the first plunger 80 as shown in FIGS. 37 to 46.

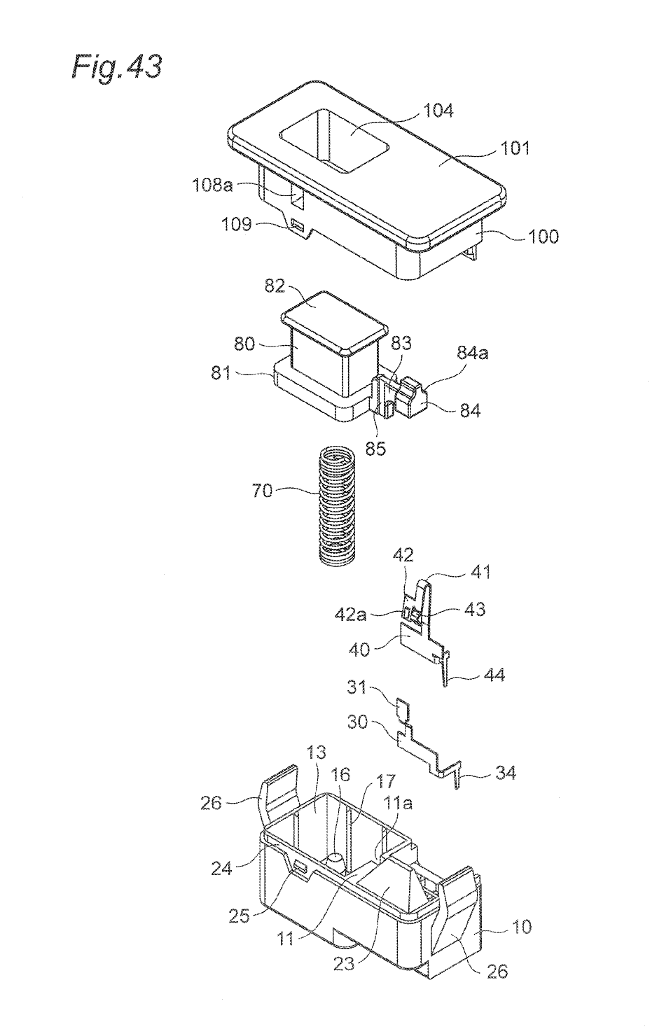

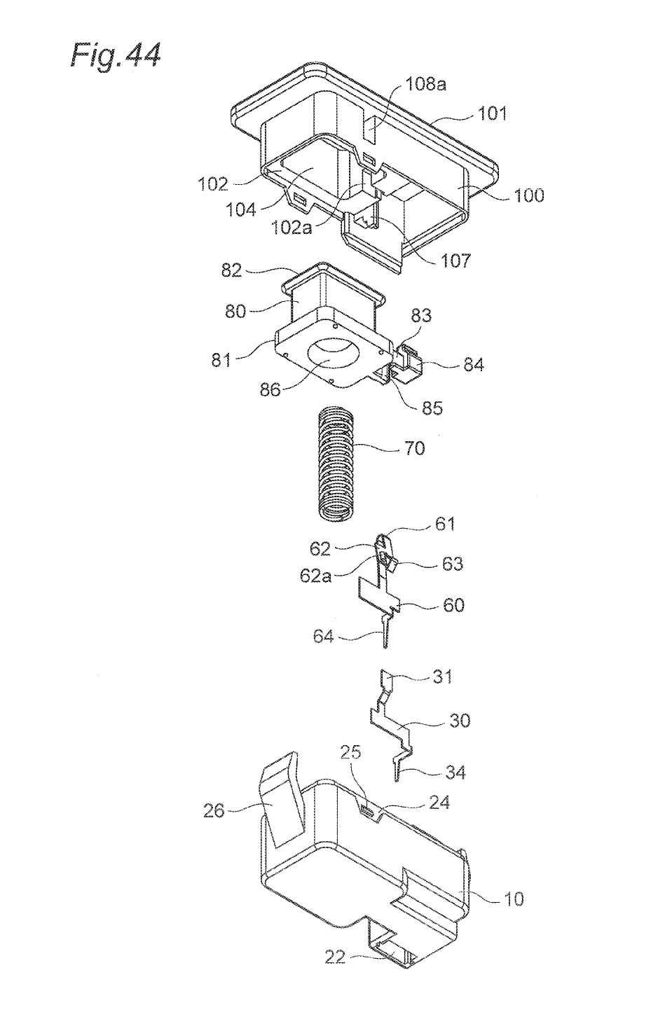

As shown in FIGS. 43 and 44, the push button switch according to the present embodiment is roughly composed of a base 10, a common fixed contact terminal 30, a first movable contact terminal 40, a first return spring 70, a first plunger 80, and a cover 100. Since the basic structure is almost the same as that of the foregoing first embodiment, the same numerals are provided to the same portions and descriptions thereof are omitted.

As shown in FIGS. 37 and 38, the first plunger 80 is in a returned position before the operation, and hence the operation body 84 is pressing and contacting the operation tongue piece 43 of the first movable contact terminal 40, and the movable contact 42a is separated from the first fixed contact 31a.

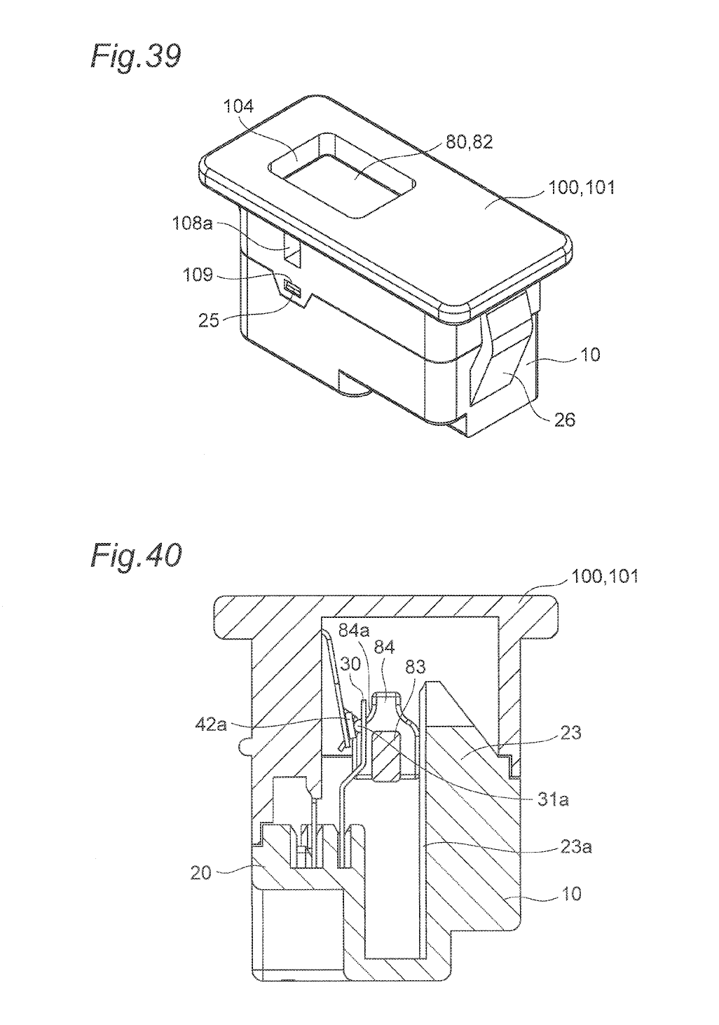

Then, as shown in FIGS. 39 and 40, when the first plunger 80 is pushed down, the operation body 84 is lowered and the operation surface 84a slides on the surface of the operation tongue piece 43, to reduce a load on the operation tongue piece 43. Hence the movable contacting piece 41 is elastically returned, and the movable contact 42a comes into contact with the first fixed contact 31a.

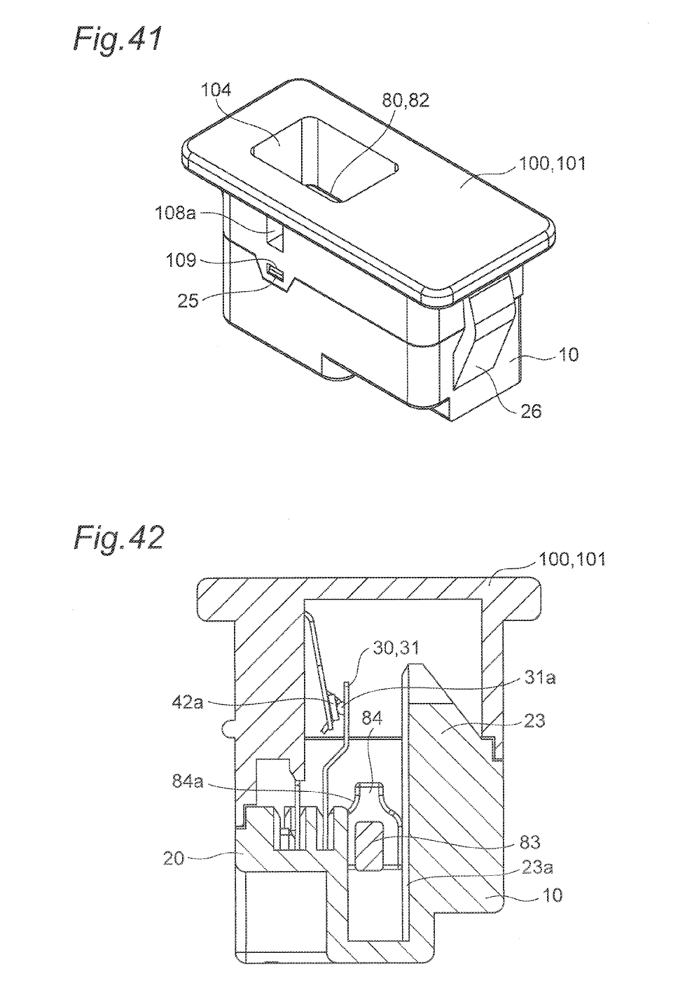

As shown in FIGS. 41 and 42, when the first plunger 80 is further pushed down, the operation body 84 is lowered, and no load is then applied from the operation body 84. The movable contact 42a comes into contact with the first fixed contact 31a with predetermined pressure.

When the push-down operation on the first plunger 80 is released, the first plunger 80 is pushed back by the spring force of the first return spring 70, and returned to the original position. Hence the operation body 84 rises, the operation surface 84a pushes back the operation tongue piece 43, and the movable contact 42a is separated from the first fixed contact 31a.

According to the present embodiment, by selecting and combining common components as necessary, it is possible to obtain push button switches with different output types. There is thus an advantage that the number of components for manufacturing a larger variety of products is substantially reduced to facilitate inventory control for the components.

### INDUSTRIAL APPLICABILITY

Needless to say that a push button switch according to the present invention is not limited to a refrigerator-freezer, but may be applied to other electric appliances and doors of buildings.

### REFERENCE SIGNS LIST

10: base

11, 12: partition wall

11a, 12a: guide groove

13: first recess

14: second recess

15: third recess

16: support projection

17: positioning rib

18: support projection

20: step

21a, 21b, 21c, 21d: terminal hole

23: protrusion

30: common fixed contact terminal

31: first fixed contact piece

31a: first fixed contact

32: second fixed contact piece

32a: second fixed contact

33: third fixed contact piece

33a: third fixed contact

34: terminal portion

40: first movable contact terminal

41: movable contacting piece

42: movable contact piece

42a: movable contact

43: operation tongue piece

44: terminal portion

50: second movable contact terminal

51: movable contacting piece

52: movable contact piece

52a: movable contact

53: operation tongue piece

54: terminal portion

60: third movable contact terminal

61: movable contacting piece

62: movable contact piece

62a: movable contact

63, 64: operation tongue piece

65: terminal portion

70: first return spring

71: second return spring

80: first plunger

81: flange portion

82: pressing portion

83: operation arm portion

84: operation body

84a: operation surface

85: guide groove

86: housing hole

90: second plunger

91: flange portion

92: pressing portion

93: operation arm portion

94: operation body

94a: operation surface

95: guide groove

96: housing hole

100: cover

102, 103: annular partition wall

102a, 103a: guide groove

104, 105: operation hole

107: retaining rib

108a: drain hole

108b: drain hole

110: mounting plate

111: mounting hole

1. A push button switch comprising:
a housing made up of a base and a cover;
a first plunger mounted on the cover so as to be pushed down, and having an operation body at a tip of an operating arm portion projecting sideways from an inner surface of the first plunger;
a movable contacting piece configured to be driven by a push-down operation on the first plunger;
a movable contact provided in the movable contacting piece; and
a fixed contact disposed so as to come into and out of contact with the movable contact, wherein
the movable contacting piece includes:
a movable contact piece provided with the movable contact; and
a first operation tongue piece disposed on one of both sides of the movable contact piece and coupled with the movable contact piece so as to rotate integrally, and wherein
the first operation tongue piece is operated by the operation body of the first plunger to bring the movable contact into and out of contact with the fixed contact.

2. The push button switch according to claim 1, wherein the push button switch comprises a second plunger mounted on the cover so as to be pushed down, and having an operation body at a tip of an operating arm portion projecting sideways from an inner surface of the second plunger,
the movable contacting piece further includes a second operation tongue piece disposed on another side of the both sides of the movable contact piece and coupled with the movable contact piece so as to rotate integrally, and
the first and second operation tongue pieces are respectively operated by the first and second plungers to bring the movable contact into and out of contact with the fixed contact.

3. The push button switch according to claim 2, wherein a first movable contacting piece and a second movable contacting piece are disposed so as to be symmetrical in the housing,
the first movable contacting piece has the first operation tongue piece disposed on one of both sides of the movable contact piece,
the second movable contacting piece is formed so as to have a relation of a mirror-image centered on an imaginary surface that separates between the first movable contacting piece and the second movable contacting piece,
the first operation tongue piece of the first movable contacting piece and the second operation tongue piece of the second movable contacting piece are respectively operated by the first and second plungers to respectively bring a first movable contact of the first movable contacting piece and a second movable contact of the second movable contacting piece into and out of contact with a first fixed contact and a second fixed contact.

4. The push button switch according to claim 3, wherein the foregoing first and second movable contacting pieces are respectively disposed on both sides of the movable contacting piece.

5. The push button switch according to claim 1, wherein the operation body has an operation surface that smoothly slides on a surface of the first operation tongue piece.

6. The push button switch according to claim 1, wherein the movable contacting piece is bent in a substantially U-shape.

7. The push button switch according to claim 1, wherein the first operation tongue piece is bent so as to protrude toward the first plunger.

8. The push button switch according to claim 1, wherein a pressing portion of the first plunger is on a same plane as a surface of the housing.

9. The push button switch according to claim 2, wherein the first and second plungers is formed so as to have a relation of a mirror-image centered on an imaginary surface that separates between the first and second plungers.

10. The push button switch according to claim 1, wherein a pair of the movable contacting pieces is formed so as have a relation of a mirror-image centered on an imaginary surface that separates between the movable contacting pieces.
